(19) United States
(12) Patent Application Publication
(10) Pub. No.: US 2010/0011059 A1
(43) Pub. Date: Jan. 14, 2010

(54) Self-Marketing System and Method

(76) Inventors: Byungwook Christopher Han, Palo Alto, CA (US); Holger Assenmacher, Eulenbis (DE); Peter Ebert, Menlo Park, CA (US); Ali Ebtekar, Palo Alto (US)

Correspondence Address: PETER EBERT, 2180 Camino De Los Robles, MENLO PARK, CA, 94025, US

(21) Appl. No.: 12/351,832

(22) Filed: Jan. 10, 2009

Related U.S. Application Data
(60) Provisional application No. 61/020,739, filed on Jan. 13, 2008.

(51) Int. Cl. G06F 15/16

(52) U.S. Cl. 709/204

(57) ABSTRACT

A system and method that allows generating, maintaining and presenting one or more self-marketing scores based on references from friends or acquaintances, preferably via a communication network such as the Internet. The respective scores can be generated in a standardized format making the scores comparable across different persons.

This application claims the benefit of Provisional Application No. 61020739 entitled “Self-Marketing System and Method”, filed on Jan. 13, 2008.

### FEDERALLY SPONSORED RESEARCH

Not Applicable

### SEQUENCE LISTING OR PROGRAM

Not Applicable

### BACKGROUND

1. Field of the Invention

The present invention relates to generating, maintaining and presenting one or more self-marketing scores based on references from friends or acquaintances, preferably via a communication network such as the Internet. The respective scores can be generated in a standardized format making the scores comparable across different persons.

2. Background of the Invention

In the increasingly popular field of social networking services, a multitude of persons are communicating and sharing information with one another typically via the Internet.

In more detail, a social networking service focuses on the building and verifying of online social networks for communities of people who share interests and activities, or who are interested in exploring the interests and activities of others.

Most social networking services are primarily web based and provide a multitude of ways for users to interact, such as chat, messaging, email, video, voice chat, file sharing, blogging, discussion groups, for example.

The main types of social networking services are those which contain directories of some categories (such as former classmates), means to connect with friends (usually with self-description pages), and recommender systems linked to trust. Popular methods now combine many of these, with MySpace, Bebo and Facebook being the mostly widely used in 2007.

A key social need for members of a social networking environment is to express and communicate individual positive attributes as a means to build and maintain a reputation that is trusted by other members of the social networking environment.

The present invention addresses this need in a novel way providing a number of advantages.

### SUMMARY

The invented system and method allows persons to generate one or more scores suited to measure and present one or more aspects of their respective personalities, strengths, integrity and the like in a standardized, cross-person comparable form.

In order to provide utmost clarity in the following description, the following terms shall be introduced and defined:
a) The term claim in the spirit of the present invention shall refer to a construct that comprises a statement and is depicted in detail in FIG. 1.
b) The term source person shall refer to a person that creates a claim.
c) The term target person shall refer to a person that a claim relates to.
d) The term friend shall be used to describe somebody who is part of a person's social network, which typically indicates at least a reasonable amount of mutual trust.
e) The term source person's friends shall refer to one or more friends of the source person.
f) The term target person's friends shall refer to one or more friends of the target person.
Source person and target person are preferably friends. Also, it shall be pointed out that at least a sub set of the source person's friends may also be target person's friends and vice versa.
g) The term vouch shall be used to indicate that a friend gives personal assurance that a claim is true. The term vouch shall be used as a noun as well as in verb form. Used as a noun, a vouch shall refer to the result of the verb form of vouch “to vouch”. Used as a noun, a vouch comprises an expression indicating whether an assurance regarding the claim was given or not and an identifier related to the person who created the vouch. In addition, a vouch may comprise, but is not limited to, one or more comments.
h) The term score in the spirit of the present invention shall refer to a metric comprising one or more quantitative or qualitative expressions as described in more detail below. A score is preferably generated in the following sequence:

1) a source person creates a claim relating to an aspect of himself or herself preferably via the Internet, for example, the claim comprising the following statement: “I am the best Java programmer in California”. In this case, the source person is equal to the target person.

2) the source person then asks one or more of his or her friends (source person's friends) to vouch that the claim is true.

3) an initial score regarding the claim is generated that is preferably updated each time a vouch for the respective statement is received, preferably representing a standardized measurement for the quantity and quality of received vouches as described below.

It is also an object of the present invention that two or more scores, each relating to two or more respective claims, may be aggregated as to generate one or more higher-level scores that can be used as a standardized measurement of the integrity of the target person that the two or more respective claims relate to.

As an alternative embodiment of the present invention, a claim may also be created by one person targeting another person. In this case, a score may, for example, be generated in the following sequence:

1) a source person creates a claim regarding an aspect of a target person preferably via the Internet, for example, “Tim Doe is the best Java programmer in California”. In this case, the source person is not equal to the target person.

Optionally, the target person, in this example Tim Doe, may need to approve the claim before the following steps are allowed to be performed:

2) the source person as well as the target person can then ask one or more of the target person's friends to vouch that the claim is true.

3) an initial score regarding the claim is generated that is preferably updated each time a vouch for the respective statement is received, preferably representing a standardized measurement for the quantity and quality of received vouches as illustrated below.

The present invention introduces a multitude of objects and advantages including commercially valuable features and services.

For example, one object and advantage of the present invention is to allow a person to illustrate or advertise, for example, an area of strength in order to attract, for example, new friends, partners or employers.

Another object and advantage of the present invention is to allow employers looking to hire employees with specific profiles to use the presently disclosed scores as part of their recruiting process. In this case, employers may improve the speed and quality of their recruiting processes, for example, by using the disclosed scores as readily available references.

Another object and advantage of the present invention is to allow advertisers to identify and engage with specific target audiences. In this case, an advertiser may wish to only engage with target audiences who feature, for example, scores above a specific minimum value, or strengths in a specific area.

Another object and advantage of the present invention is that the invented system and method may also be applied to generating one or more scores suited to measure and present aspects of an organization's strengths, capabilities, integrity or the like using the same or a similar process as described above and in the following description regarding persons. In this case, for example, one organization may publish a claim regarding itself or another organization and asks partner organizations of the target organization to vouch for the claim, in the same or similar way as described above.

The term organization shall be used in the context of the present invention to include a corporation, business trust, estate, trust, partnership or association, or any other legal for-profit or non-profit entity.

For an organization, an object and advantage of the present invention is to allow the organization to illustrate or advertise, for example, an area of its strengths in order to attract, for example, new partners, customers, or investors.

Another object and advantage of the present invention is to allow organizations to identify and engage with specific other organizations. In this case, an organization may wish to only engage with other organizations who feature, for example, scores above a specific minimum value, or strengths in a specific area.

It will be apparent to those skilled in the art that a multitude of non-commercial and commercial services may be enabled by applying the invented system and method, including, but not limited to, research services, entertainment services, partnership services, recruiting services and advertisement services.

Additional objects and advantages of the present invention will become apparent to those skilled in the art based on the following drawings and detailed description.

### DRAWINGS

FIG. 1 depicts the structure of a claim.

FIG. 2 shows an example of a claim that a person made regarding himself.

FIG. 3 shows an example of a claim that a person made regarding a friend of the person.

FIG. 4 is a block diagram depicting a generation of a score.

FIG. 5A is a screenshot of a first step of a prototypical web-based application that illustrates how a source person may create a claim relating to himself or herself.

FIG. 5B is a screenshot of a second step of a prototypical web-based application that illustrates how a source person may input a statement as part of the claim of FIG. 5A.

FIG. 5C is a screenshot of a third step of a prototypical web-based application that illustrates how a source person may ask at least a subset of his or her friends to vouch for the claim of FIG. 5A.

FIG. 5D is a screenshot of a first step of a prototypical web-based application that illustrates how a source person may create a claim relating to a friend.

FIG. 5E is a screenshot of a second step of a prototypical web-based application that illustrates how a source person may input a statement as part of the claim of FIG. 5D relating to a friend .

FIG. 5F is a screenshot of a third step of a prototypical web-based application that illustrates how a source person may ask at least a subset of the target person's friends to vouch for the claim of FIG. 5D.

FIG. 6 is a screenshot of a prototypical web-based application that depicts how a request to vouch for a claim may be presented to a target user's friend.

FIG. 7 is a screenshot of a prototypical web-based application that depicts an alternative view of how a request to vouch for a claim may be presented to a target user's friend.

FIG. 8 is a screenshot of a prototypical web-based application that illustrates how a source person may be enabled to look at and interact with a list of claims that either the source person has published or that have been published regarding the source person.

FIG. 9 is a screenshot of a prototypical web-based application that illustrates how a source person may be enabled to look at and interact with a list of claims that friends of the source person have published.

FIG. 10 is a screenshot of a prototypical web-based application that illustrates how a source person may be enabled to look at and interact with all claims that the source person currently has access to.

FIG. 11 is a screenshot of a prototypical web-based application that allows a person to see and interact with various aspects of the present invention in one view.

FIG. 12 is a block diagram depicting a system in the spirit of the present invention.

### DETAILED DESCRIPTION

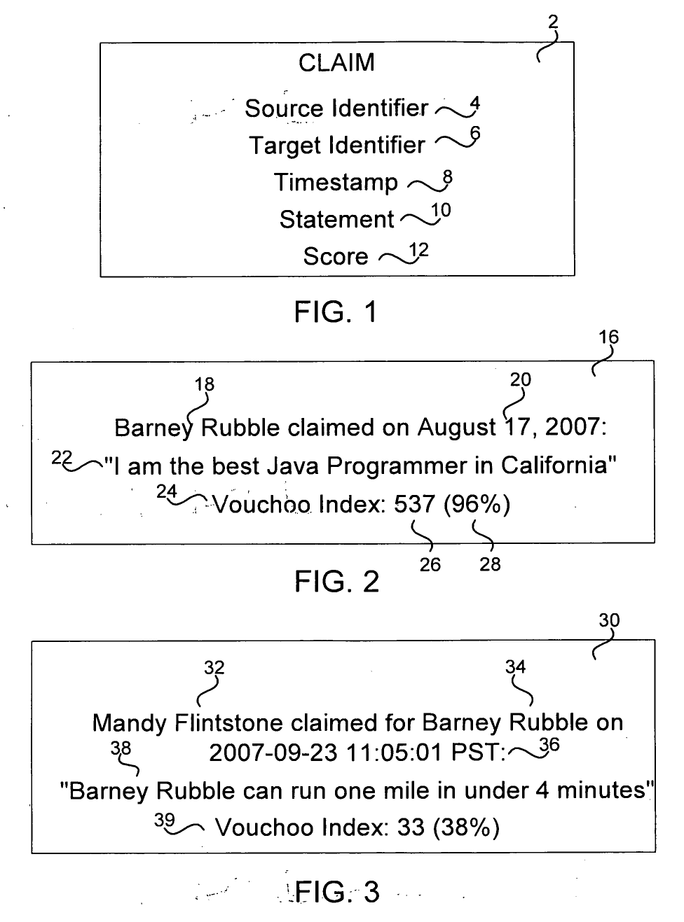

FIG. 1 depicts the preferred structure of a claim in the spirit of the present invention. Claim 2 contains a source identifier 4, a target identifier 6, a timestamp 8, a statement 10 and a score 12.

In the context of the present invention, the term source identifier shall be used as a preferably unambiguous reference to a source person and the term target identifier shall be used as a preferably unambiguous reference to a target person.

Examples for an identifier for a person shall include a combination of a first name, optionally middle name and a last name, a number or series of numbers and characters, such as a user name that is linked to a particular person, or the like.

The term timestamp shall be used to refer to the date and time when a claim was created.

The term statement shall be used to refer to a verbal description of one or more aspects of, for example, a target person's strengths, conduct, or integrity.

The term score is defined above. A score in the spirit of the present invention is preferably intended to be used as a metric for a claim's credibility and is preferably designed to allow easy readability and comparability across two or more claims.

FIG. 2 shows an example of a claim 16 that a source person made regarding himself. In this case, the name of the source person creating the claim 16 as well as the target person that the claim 16 is related to, is “Barney Rubble”. In this case, identifier 18, which consists of the first and last name of the source person, represents both, the source identifier and the target identifier.

Timestamp 20 depicts the date and time when claim 16 was created. In the illustrated case, for usability reasons, timestamp 20 only shows a date, which is Aug. 17, 2007. Of course, timestamp 20 could also be expressed in a much more comprehensive and granular form, for example, as “2007-08-17 13:27:44 PST” which includes a date, time and respective time zone.

In addition, claim 16 includes a statement 22 “I am the best Java Programmer in California”.

Furthermore, claim 16 includes a score 24 called “Vouchoo Index”. Score 24 consists of a quantity indicator 26 and a quality indicator 28. Quantity indicator 26 shows that 537 vouches have been received so far regarding claim 16. Quality indicator 28 shows that 96% of the friends of the target person at the time claim 16 was published have vouched for claim 16 so far. Or, as expressed in more general terms:

X=total number of vouches received regarding a claim z so far;

y=total number of the claim z's target person's friends at the time when the claim z was published (the target person is the person that the claim z relates to);

Quantity indicator value=x;

Quality indicator value [%]=100* x/y

Exceptions:
a. if y equals 0 then Quality indicator value shall equal 0%;
b. if Quality indicator value is greater than 100% then Quality indicator value shall equal 100%.

Vouchoo Index for the claim z:

Quantity indicator value for claim z (Quality indicator for claim z [%]).
Example 1: for x=5 and y=10: Vouchoo index=5 (50%);
Example 2: for x=300 and y=10: Vouchoo index=300 (100%);
Example 3: for x=0 and y=10: Vouchoo index=0 (0%);
Example 4: for x=50 and y=0: Vouchoo index=0 (0%).

While the above described way to compute and present a score is an object of the present invention, there is a multitude of alternative ways. For example, the value of quality indicator 28 may also be influenced by how slow or fast vouches for claim 16 have been received, the time elapsed since claim 16 has been created as to account for aging effects that may influence the validity of statement 22 over time, for how long friends that vouched for claim 16 were registered as friends of Barney Rubble upon vouching for claim 16 and the like.

Of course, score 24 may also be expressed in a multitude of alternative formats. For example, score 24 may include additional or alternative indicators or indicators with additional or alternative value spaces.

FIG. 3 shows an example of a claim 30 that a person made regarding another person. In this case, the name of the source person is “Mandy Flintstone” 32 and the name of the target person is “Barney Rubble” 34. In this case, as illustrated, “Mandy Flintstone” represents the source identifier 32 and “Barney Rubble” the target identifier 34.

Timestamp 36 depicts the date and time when claim 30 was created, in this case formatted as “2007-09-23 11:05:01 PST” which includes a date, time and respective time zone.

In addition, claim 30 includes a statement 38 “Barney Rubble can run one mile in under 4 minutes”.

Furthermore, claim 30 includes a score 39 called “Vouchoo Index” that is computed and presented in the same way as score 24 described above. Comparing score 24 with score 39, it will be apparent that only 33 vouches have been received for claim 30 thus far (versus 537 for claim 16) and also that only 38% of friends asked to vouch for claim 30 have done so as of yet (versus 96% for claim 16). Thus, claim 16 features a much higher credibility ranking than claim 30 at this time.

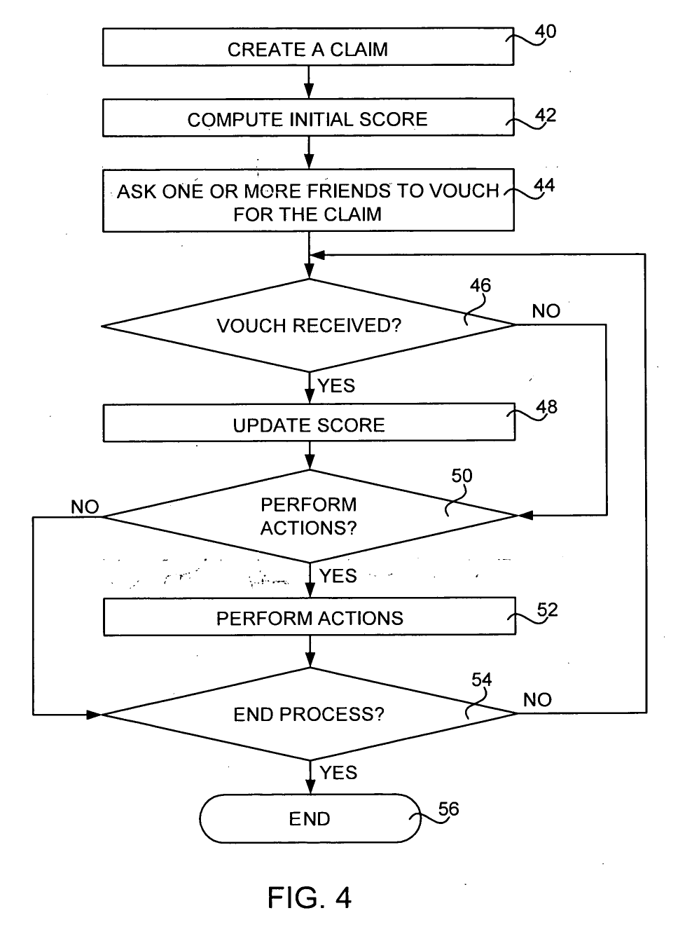

FIG. 4 is a block diagram depicting a preferred generation of a score. In step 40, typically via the Internet, a source person creates a claim for a target person.

In step 42, an initial score is computed and included in the claim by a system in the spirit of the present invention, the initial score being, for example, a Vouchoo Index with the quantity and quality values 0 (0%), since no vouches have been received for the claim yet.

In step 44, at least one of, the source person and the target person, ask the target person's friends to vouch for the claim.

In step 46, if a vouch regarding the claim has been received, the score related to the claim is updated in step 48 at least partly influenced by the respective quantity and quality of all vouches received at that time.

Either if no vouch is received in step 46, or upon updating the score in step 48, step 50 is performed. In step 50, if there are to be performed actions such as, for example, alerting subscribed persons about the changed score, these actions are being performed in step 52.

Either if there are no actions to be performed in step 50, or upon performing actions in step 52, step 54 is performed. In step 54, if the process of generating a score is not to be ended, step 46 is performed . In step 54, if the process of generating a score is to be ended, the process is ended in step 56.

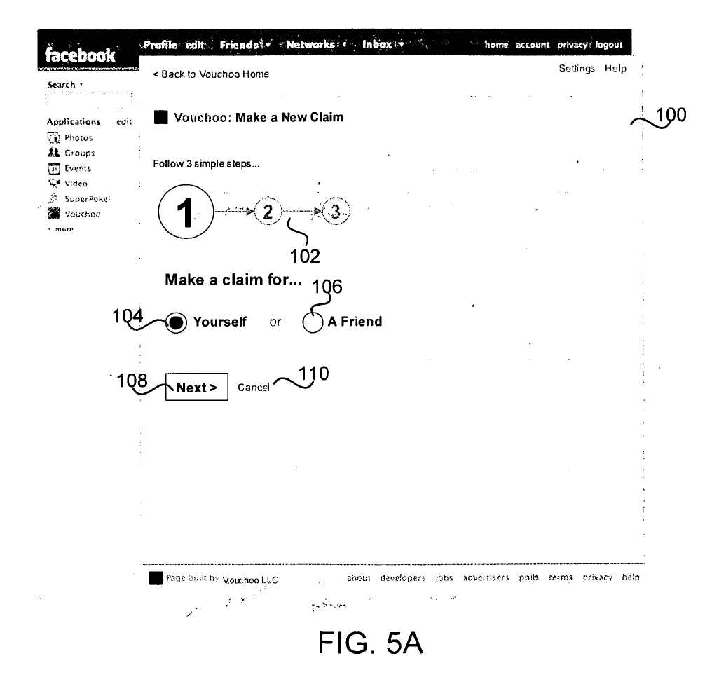

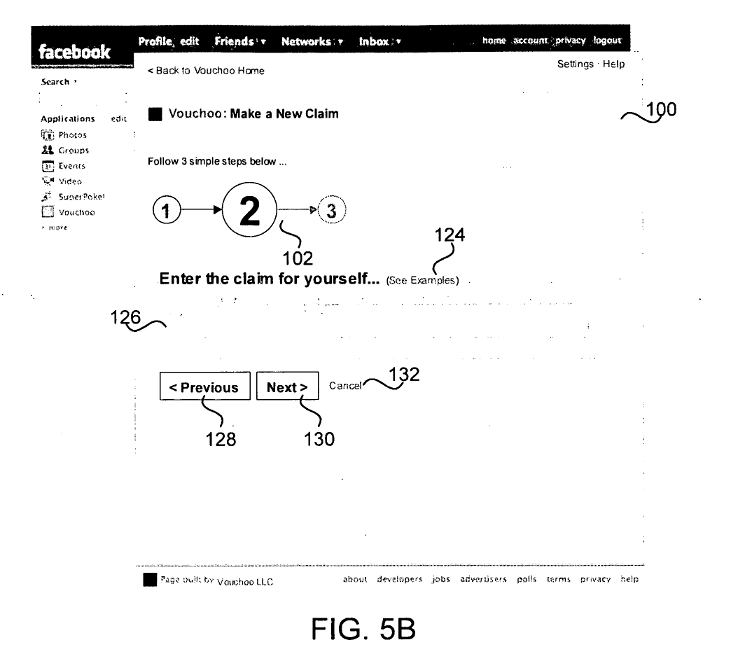

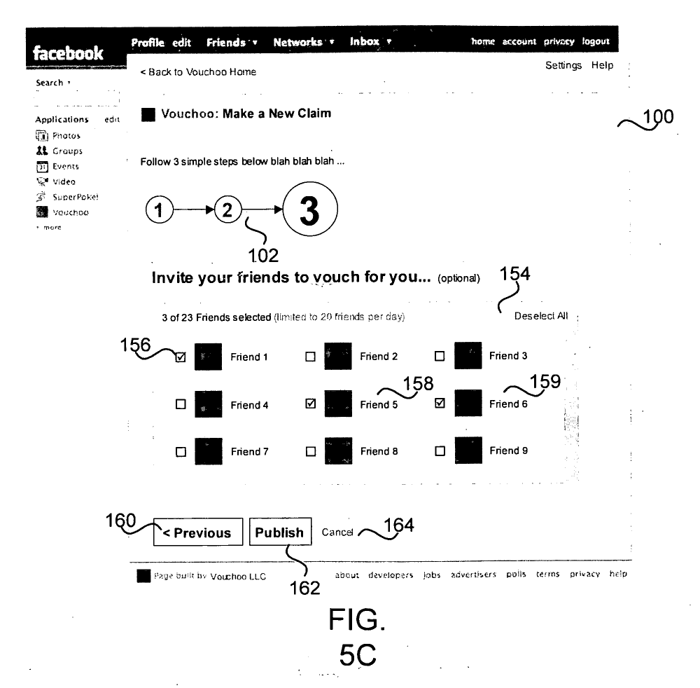

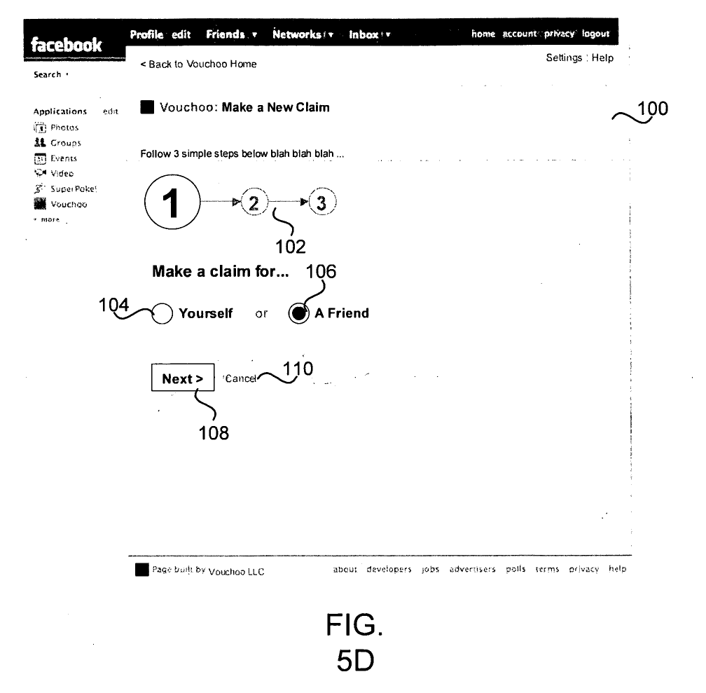

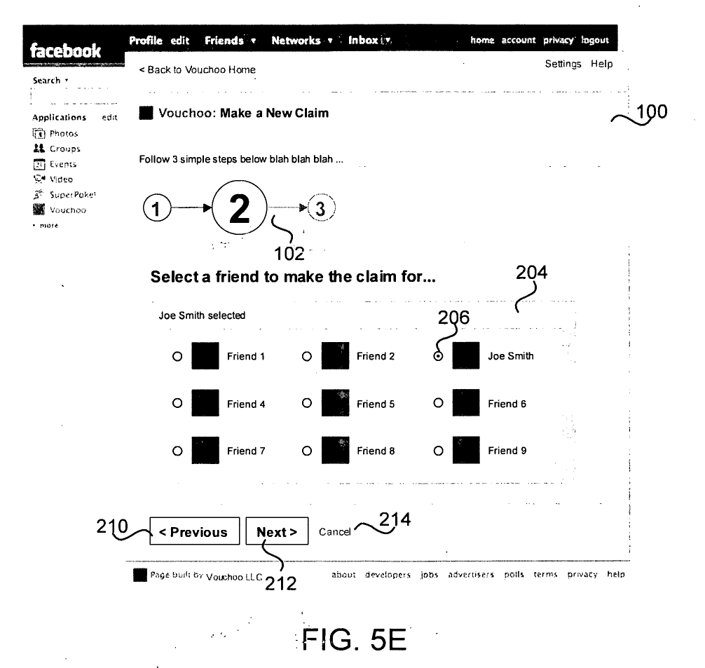

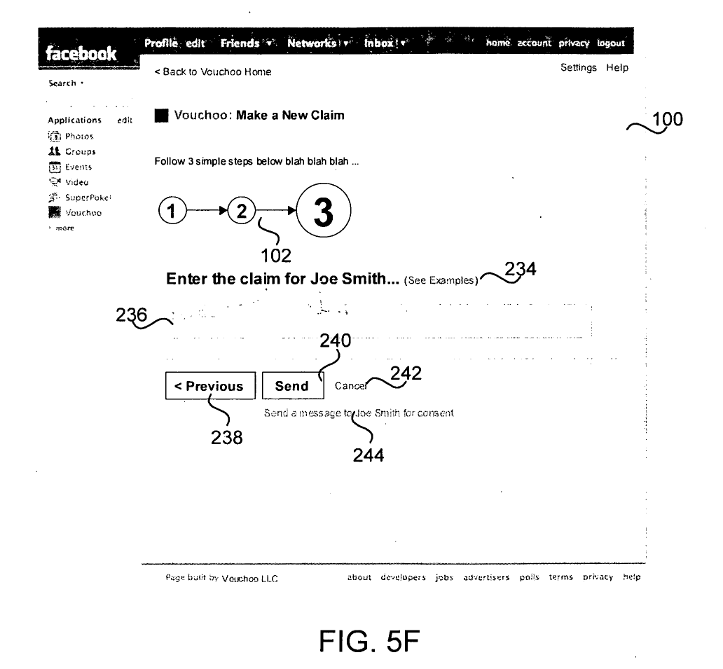

FIG. 5A is a screenshot of a first step of a prototypical web-based application that illustrates how a source person may create a claim relating to himself or herself. The application is designed to integrate with Facebook, a very popular social networking website. Of course, the following functionality may be implemented with an alternative technology and be integrated into an alternative website that allows to create a claim in the spirit of the present invention.

Form 100 comprises a step indicator 102 that is currently indicating a step 1. Furthermore, form 100 comprises a selector for choosing a target person comprising an option “Yourself” 104 and an option “A Friend” 106. Option 104 is selected meaning that the source person selected to create a claim relating to himself or herself.

In addition, form 100 comprises a button “Next” 108 and a link “Cancel” 110. Clicking on link 110 allows to leave form 100 without further processing. In this case, the source person clicks on button 108 in order to move to step 2 of form 100 depicted in FIG. 5B.

FIG. 5B depicts a screenshot illustrating a second step of the prototypical web-based application depicted in FIG. 5A. Step indicator 102 shows that step 2 of form 100 is currently active. Clicking link “See Examples” 124 shows one or more examples of well designed claim statements to the source person as to support the source person in formulating an appropriately designed statement for the present claim. Text input field 126 allows the source person to input a statement for the present claim, for example, “I am the best Java programmer in California”.

In addition, form 100 comprises a button 128 that leads back to step 1 depicted in FIG. 5A. Form 100 also comprises a button “Next” 130 and a link “Cancel” 132. Clicking on link 132 allows to leave form 100 without further processing. In this case, the source person clicks on button 130 in order to move to step 3 of form 100 depicted in FIG. 5C.

FIG. 5C depicts a screenshot illustrating a third step of the prototypical web-based application depicted in FIG. 5B. Step indicator 102 shows that step 3 of form 100 is currently active. Friend selector 154 shows a list of the target person's friends allowing to select one or more of the identifiers of the presented friends' names. Of course, this list could be scrollable as to accommodate for a larger number of friends. The identifiers of Friend 1 156, Friend 5 158 and Friend 6 159 are selected meaning these friends shall be asked to vouch for the present claim.

In addition, form 100 comprises a button 160 that leads back to step 2 depicted in FIG. 5B. Form 100 also comprises a button “Publish” 162 and a link “Cancel” 164. Clicking on link 164 allows to leave form 100 without further processing. In this case, the source person clicks on button 162 in order to include the present claim in the source person's profile that is illustrated in FIG. 13. and request vouches from the selected friends 156,158 and 159.

FIG. 5D is a screenshot of a first step of a prototypical web-based application that illustrates how a source person may create a claim relating to a friend of the source person.

Form 100 comprises a step indicator 102 that is currently indicating a step 1. Furthermore, form 100 comprises a selector for choosing a target person comprising an option “Yourself” 104 and an option “A Friend” 106. Option 106 is selected meaning that the source person selected to create a claim relating to a friend of the source person.

In addition, form 100 comprises a button “Next” 108 and a link “Cancel” 110. Clicking on link 110 allows to leave form 100 without further processing. In this case, the source person clicks on button 108 in order to move to step 2 of form 100 depicted in FIG. 5E.

FIG. 5E depicts a screenshot illustrating a second step of the prototypical web-based application depicted in FIG. 5D. Step indicator 102 shows that step 2 of form 100 is currently active. Friend selector 204 shows a list of the source person's friends allowing to select one of the identifiers of the presented friends' names. Of course, this list could be scrollable as to accommodate for a larger number of friends. The identifier of Joe Smith 206 is selected meaning the present claim shall be created related to Joe Smith 206.

In addition, form 100 comprises a button “Previous” 210, a button “Next” 212 and a link “Cancel” 214. Clicking on link 214 allows to leave form 100 without further processing. Clicking on button “Previous” 210 leads back to step 1 depicted in FIG. 5D. In this case, the source person clicks on button “Next” 212 in order to move to step 3 of form 100 depicted in FIG. 5F.

FIG. 5F depicts a screenshot illustrating a third step of the prototypical web-based application depicted in FIG. 5D. Step indicator 102 shows that step 3 of form 100 is currently active. Clicking link “See Examples” 234 shows examples of well designed claim statements of claims targeting a target person as to support the source person in formulating an appropriately designed statement for the present claim. Text input field 236 allows the source person to input a statement for the present claim, for example, “Joe Smith is the best dancer in Palo Alto”.

In addition, form 100 comprises a button “Previous” 238 that leads back to step 2 depicted in FIG. 5E. Form 100 also comprises a button “Send” 240 and a link “Cancel” 242. Clicking on link 242 allows to leave form 100 without further processing. In this case, the source person clicks on button “Send” 240 in order to send the present claim to the target person “Joe Smith” for consent as indicated in text 244.

As an alternative embodiment, of course, the present claim may also be published directly without the need to ask for the target person's consent, much as illustrated in FIG. 3C.

In either case, as soon as the present claim has been added to the target person's profile, the target person may ask one or more of the target person's friends to vouch for the present claim.

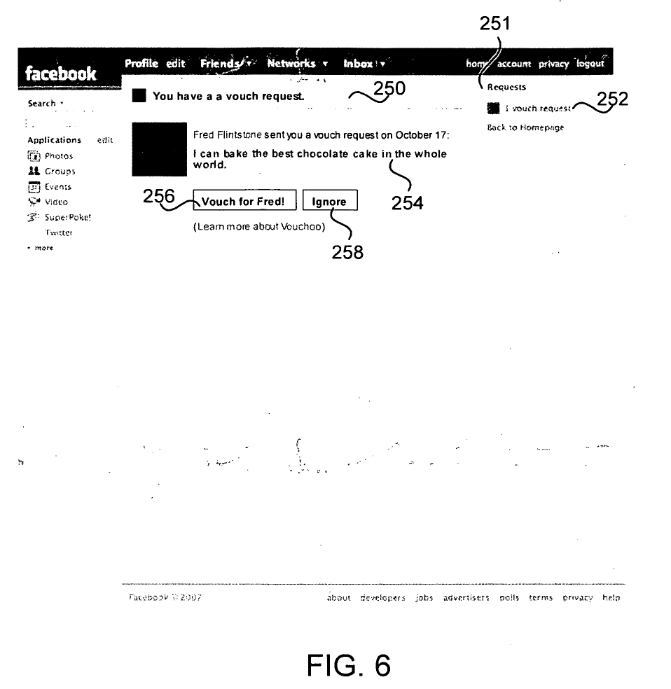

FIG. 6 is a screenshot of a prototypical web-based application that depicts how a request to vouch for a claim may be presented to a target user's friend. Upon clicking on the link “1 vouch request” 252 in the request list control 251, form 250 is presented to a target user's friend of “Fred Flintstone”. The form 250 shows a claim 254 and two buttons 256 and 268. Clicking on button “Vouch for Fred!” 256 allows the present target user's friend to vouch for claim 254, while button “Ignore” 258 allows the present target user's friend to avoid vouching for claim 254 at this time.

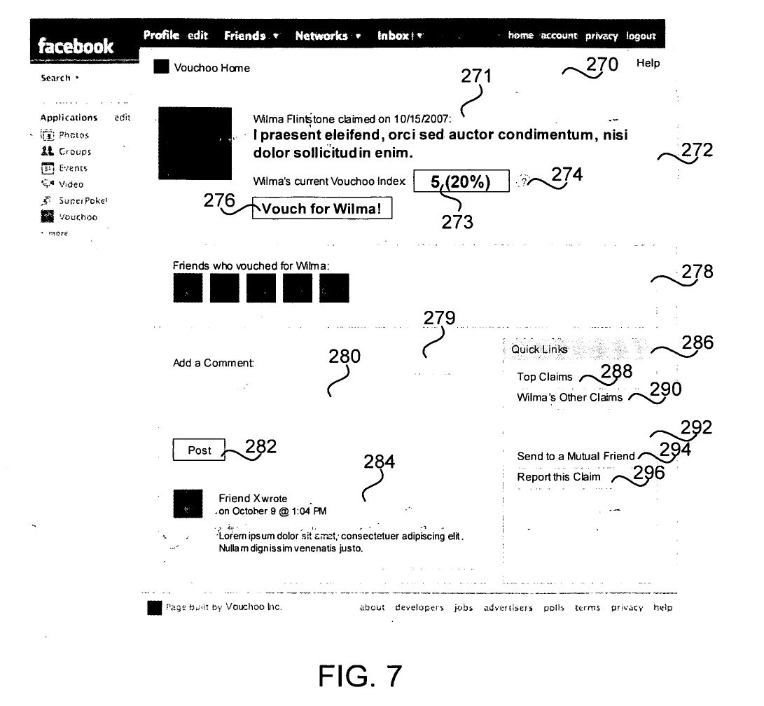

FIG. 7 is a screenshot of a prototypical web-based application that depicts an alternative view of how a request to vouch for a claim may be presented to a target user's friend.

Form 270 contains a vouch control 272, a friends control 278, a comment control 279, a quick link control 286 and a function control 292.

Claim control 272 depicts a claim 271, the claim's 271 current score 273, a help link 274 and a vouch button 276. Upon clicking on help link 274, for example, an explanation of how the score 273 is being computed may be presented (not shown).

Upon clicking on vouch button 276, score 273 is updated accordingly and the vouch button 276 may, for example, become inactive (not shown) as to prevent multiple vouches from the same person.

Friends control 278 shows a list of icons representing none or more friends who already vouched for claim 271.

Comment control 279 allows to publish one or more comments regarding claim 271. In this case, a comment may be input into text control 280 and then published using button “Post” 282. Upon posting a comment, the comment may be listed as part of the comment control, for example, in the same way as comment 284.

Quick link control 286 shows one or more links that may be of particular interest for a person using form 270. For example, link “Top claims” 288 may bring up a list of the claims with the currently highest scores across all friends of the person using form 270. As another example, link “Wilma's Other Claims” 290 may bring up a list of all other claims relating to the target person of claim 271.

Function control 288 shows one or more links that enable additional functionality. For example, link “Send to a mutual friend” 294 may allow to forward a vouch request regarding claim 271 to a friend of both, the target person of claim 271 as well as the person currently using form 270.

As another example, link “Report this Claim” 296 may allow the person currently using form 270 to raise a concern, for example, in case the nature or wording of claim 271 is perceived offensive.

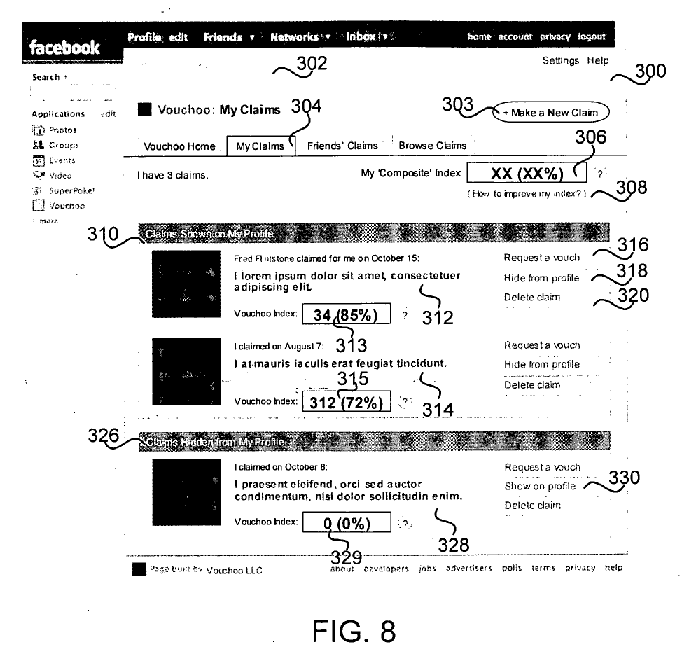

FIG. 8 is a screenshot of a prototypical web-based application that illustrates how a source person may be enabled to look at and interact with a list of claims that either the source person has published or that have been published regarding the source person.

Form 300 comprises a search term input field 302, a “Make a New Claim” button 303, a “My Claims” tab control 304 that is currently selected, a “My Composite Index” indicator 306 and a “How to improve my index” link 308. In addition, form 300 contains two claim list controls 310 and 326.

Search term input field 302 allows to input a search term that is used to filter claims that are presented in claim list controls 310 and 326 in such a way that only claims containing the search term are shown.

“Make a New Claim” button 303 links to a form allowing input of a new claim, such, for example, illustrated in FIG. 5A.

“My Composite Index” indicator 306 shows the current composite score of the person using form 300.

The term composite score shall be used to refer to an aggregation of two or more scores relating to the person using form 300. A composite score may, for example, be computed by adding all quantity indicator values of all claims that relate to the same target person, as well as adding all respective quality indicators and dividing the result by the total number of quantity indicators. For example, as illustrated in FIG. 8. composite indicator 306 may be computed by adding the quantity indicator values of 313, 315 and 329 of claims 312, 314 and 328 respectively, resulting in 34+312+0=346,as well as adding the respective quantity indicator values and dividing the results by the number of the respective quantity indicator values (85%+72%+0%)/3=52.333 . . . %, resulting in a composite score of 346 (52.333 . . . %). Of course, a number of alternative ways to compute a composite score may be applied, preferably as long as composite scores are computed in a consistent way across all persons the respective composite scores are related to.

Clicking on “How to improve my index” link 308 may present information to the person using form 300 that explains how to improve the person's present composite score 306 as, for example, to nurture adoption of the composite score as a means to demonstrate a high level of integrity. Composite score 306 may, for example, be used by a person that the composite score is related to, as a reference when the person applies for a job. Additionally, composite scores may be used by businesses to identify a candidate for a job with the highest level of integrity. Of course, a number of additional or alternative applications of a composite score are possible as a composite score can be understood and used as an indicator for the quality of the reputation of a person.

Claim list control 310 shows a list of the claims that relate to the present source person (the person who is currently logged in) and are currently visible to other persons that can see the present source person's profile. In the illustrated case, claim list control 310 comprises two claims 312 and 314.

The term profile shall be used here to refer to one or more pieces of information that relate to a person in the context of a social network service, typically comprising, for example, the person's name or identifier, location, number of friends and such.

Claim list control 326 shows a list of the claims that relate to the present source person (the person who is currently logged in) and are currently not visible to other persons that can see the present source person's profile. In the illustrated case, claim list control 310 comprises claim 328.

Using function link “Show on Profile” 330, the source person can make claim 328 visible on the source person's profile. In this case, claim 328 would be added to claim list control 310 and removed from claim list control 326.

Using function link “Hide from Profile” 318, the source person can make claim 312 invisible on the source person's profile. In this case, claim 312 would be added to claim list control 326 and removed from claim list control 310.

Using function link “Request a Vouch” 316, the source person can send a request to a selection of the source person's friends to vouch for claim 312.

Using function link “Request a Vouch” 316, the source person can delete claim 312. In this case, claim 312 would be removed from both, claim list control 310 and claim list control 326. In addition, claim 312 would be hidden from the source person's profile.

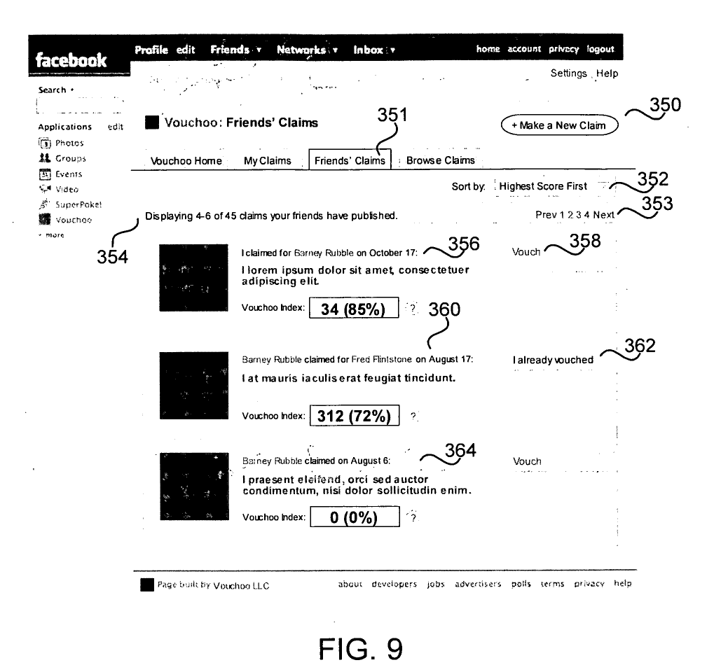

FIG. 9 is a screenshot of a prototypical web-based application that illustrates how a source person may be enabled to look at and interact with a list of claims that friends of the source person have published.

Form 350 comprises a “Friends' Claims” tab control 351 that is currently selected, a sort control 352 and a claim list control 354.

Claim list control 354 comprises a list of the claims that friends of the present source person (the person who is currently logged in) have published. In the illustrated case, claim list control 310 currently shows three claims 356, 360 and 364. Navigation control 353 allows to show additional claims that are listed as part of claim list control 310 but are currently not visible, for example, due to space limitations.

Using sort control 352, the list of presented claims may be sorted according to a selected criteria, for example, in order to show the claim with the currently highest score on top of the list, the claim with the second highest score below and so forth.

Using function link 358, the present source person can vouch for claim 356. Upon vouching for a claim, no further vouching on the claim by the present source person shall be possible. Indicator 362 illustrates this case related to claim 360 as the present source person already vouched for claim.

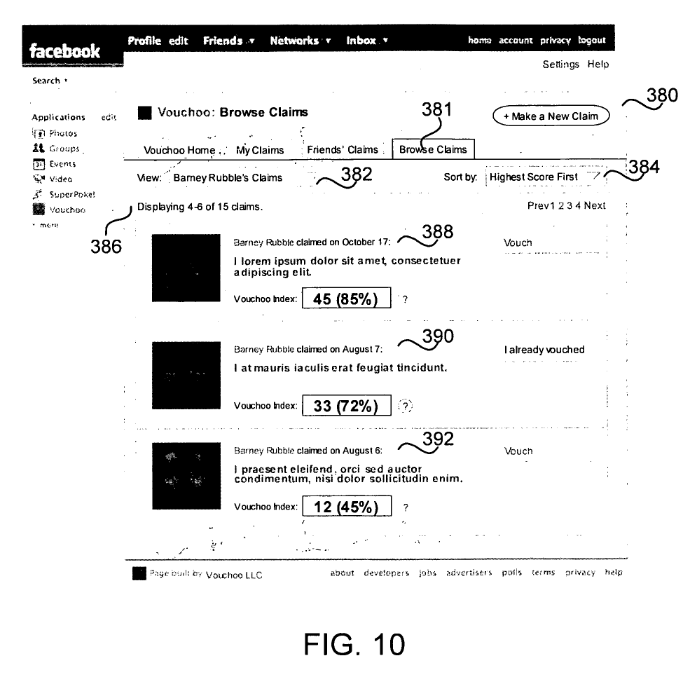

FIG. 10 is a screenshot of a prototypical web-based application that illustrates how a source person may be enabled to look at and interact with all claims that the source person currently has access to.

Form 380 comprises a “Browse Claims” tab control 381 that is currently selected, a view control 382, a sort control 384 and a claim list control 386.

Claim list control 386 comprises a list of the claims that the present source person (the person who is currently logged in) has access to. In the illustrated case, claim list control 386 currently shows three claims 388, 390 and 392. View control 382 allows to filter the claims presented in claim list control 386, for example, in order to only show claims related to a person with the name “Barney Rubble” (as illustrated). Of course, additional or alternative filter values may be provided.

In addition, using sort control 384, the list of presented claims may be sorted according to a selected criteria, for example, in order to show the claim with the currently highest score on the top of the list, the claim with the second highest score below and so forth.

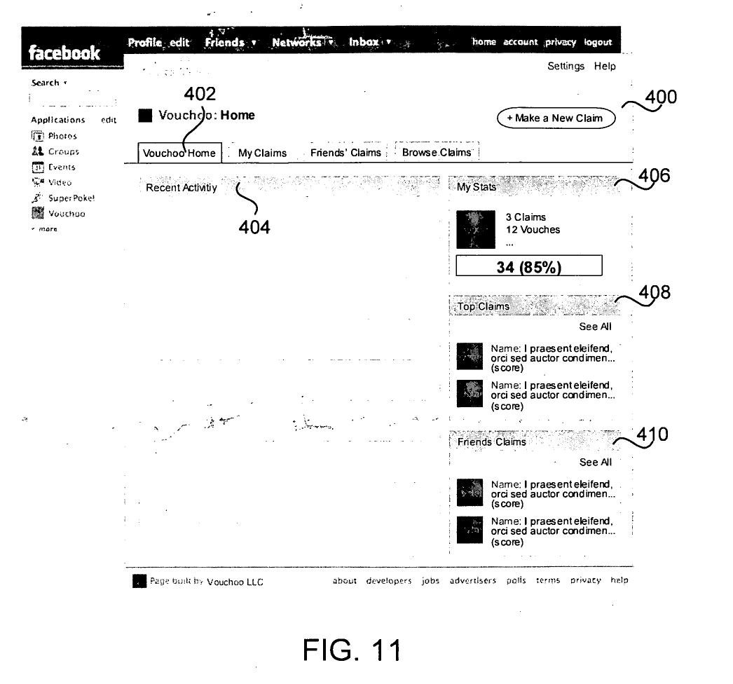

FIG. 11 is a screenshot of a prototypical web-based application that allows a person to see and interact with various aspects of the present invention in one view.

Form 400 comprises a “Vouchoo Home” tab control 402 that is currently selected, a “Recent Activity” list control 404, a “My Stats” control 406, a “Top Claims” control 408 and a “Friends° Claims” control 410.

“Recent Activity” list control 404 may comprise, for example, a list of recent vouches, messages from friends related to claims, comments received and the like (not shown).

“My Stats” control 406 may comprise, for example, the current number of claims published by the present source person (the person who is currently logged in), the number of received vouches and the current composite score of the present source person.

“Top claims” control 408 may comprise, for example, the two claims with the currently highest scores that the present source person has access to.

“Friends' claims” control 410 may comprise, for example, the two claims with the currently highest scores that relate to friends of the source person.

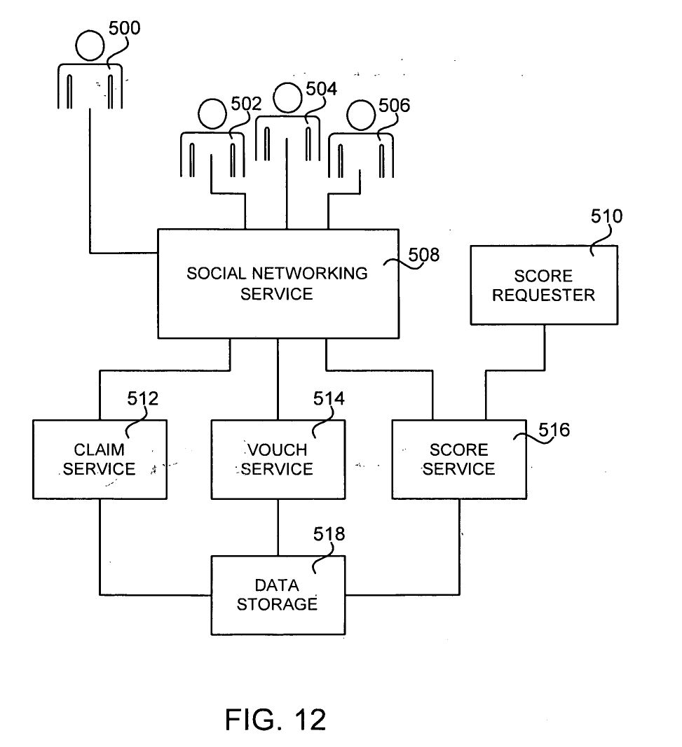

FIG. 12 is a block diagram depicting an example of a system in the spirit of the present invention.

Source person 500 is a member of a social networking service 508 as are three friends of the source person 500: friend 502, friend 504 and friend 506.

Claim service 512, vouch service 514 and score service 516 are operationally connected with social networking service 508 via the Internet and allow social networking service 508 to provide the above described functionality to its members in the spirit of the present invention as described above.

Claim service 512, vouch service 514 and score service 516 use data storage 518 to store and retrieve data, such as claim data, vouch data, comments, score data and the like.

Score requester 510, for example an employer looking to hire a person with a desired minimum score from among the members of social networking service 508, may request a list of members of social networking service 508 adhering to the desired minimum score from score service 516 for a fee.

### CONCLUSIONS

The inventions set forth above are subject to many modifications and changes without departing from the spirit, scope or essential characteristics thereof. Other embodiments of this invention will be obvious to those skilled in the art in view of the above disclosure. Thus, the embodiments explained above should be considered in all respect as being illustrative rather than restrictive of the scope of the inventions as defined in the appended claims.

### SEQUENCE LISTING

Not Applicable

What is claimed is:

1. A method for creating, presenting and vouching for a claim relating to a person, comprising:
providing means permitting the creation of a claim relating to a person;
providing means allowing one or more friends of said person to vouch for said claim;
providing means permitting the computation of a score related to said claim using a result of said vouches.

2. The method of claim 1, wherein the method further comprises the acts of:
providing means permitting the ranking of said score according to one or more criteria.

3. The method of claim 1, wherein the method further comprises the acts of:
providing means permitting the ranking of said score against scores related to claims that are not related to said person or friends of said person.

4. The method of claim 1, wherein said claim is related to the same person that created said claim.

5. The method of claim 1, wherein said claim is related to a friend of said person that created said claim.

6. The method of claim 5, wherein the method further comprises the acts of:
providing means permitting said friend of said person to reject said claim,
whereby said claim will not become visible to persons other than the creator of said claim and the person related to said claim.

7. The method of claim 1, wherein said score can be used to indicate or rank a strength of said person.

8. The method of claim 1, wherein said score contains an indicator for a quantity of received vouches.

9. The method of claim 1, wherein said score contains an indicator for a quality of received vouches.

10. The method of claim 1, wherein said claim contains a source identifier of the person who created said claim, a target identifier of the person that the claim relates to, a timestamp relating to the time when the claim was created, a statement, and a score.

11. The method of claim 3, wherein said scores can be used to identify one or more persons adhering to one or more criteria within a pluralility of persons, each person that is part of said plurality of persons being related to at least one claim.

12. A system for creating, presenting and vouching for a claim relating to a person, comprising:
means permitting the creation of a claim relating to a person;
means allowing one or more friends of said person to vouch for said claim;
means permitting the computation of a score related to said claim using a result of said vouches.

13. The system of claim 12, wherein the system further comprises:
means permitting the ranking of said score according to one or more criteria.

14. The system of claim 12, wherein the system further comprises:
means permitting the ranking of said score against scores related to claims that are not related to said person or friends of said person.

15. The system of claim 12, wherein said claim is related to the same person that created said claim.

16. The system of claim 12, wherein said claim is related to a friend of said person that created said claim.

17. The system of claim 12, wherein the system further comprises:
means permitting said friend of said person to reject said claim, whereby said claim will not become visible to persons other than the creator of said claim and the person related to said claim.

18. The system of claim 12, wherein said score can be used to indicate or rank a strength of said person.

19. The system of claim 12, wherein said score contains an indicator for a quantity of received vouches.

20. The system of claim 12, wherein said score contains an indicator for a quality of received vouches.

21. The system of claim 12, wherein said claim contains a source identifier of the person or entitiy who created said claim, a target identifier of the person that the claim relates to, a timestamp relating to the time when the claim was created, a statement, and a score.

22. The system of claim 14, wherein said scores can be used to identify one or more persons adhering to one or more criteria within a pluralility of persons, each person that is part of said plurality of persons being related to at least one claim.
